(19) United States
(12) Patent Application Publication
(10) Pub. No.: US 2025/0063280 A1
(43) Pub. Date: Feb. 20, 2025

(54) ACOUSTIC MODULE AND ELECTRONIC DEVICE

(71) Applicant: Huawei Technologies Co., Ltd., Shenzhen (CN)

(72) Inventors: Dongdong Han, Xi'an (CN); Anmin Guo, Xi'an (CN); Lei Zhang, Xi'an (CN); Hao Xiong, Wuhan (CN); Yunchao Li, Xi'an (CN); Yamin Zhou, Dongguan (CN)

(21) Appl. No.: 18/934,865

(22) Filed: Nov. 1, 2024

Related U.S. Application Data
(63) Continuation of application No. PCT/CN2023/091354, filed on Apr. 27, 2023.

(30) Foreign Application Priority Data
May 5, 2022 (CN) 202210483757.5

(51) Int. Cl. H04R 1/02

(52) U.S. Cl. CPC H04R 1/025; H04R 1/023; H04R 2499/15

(57) ABSTRACT

An acoustic module includes a speaker mesh and a fastener. The speaker mesh includes a first end face and a second end face that are opposite to each other. The first end face is provided with an installation cavity that is recessed to the second end face. The second end face is provided with a plurality of sound holes that are connected to the installation cavity. The first end face is configured to abut against a housing of the electronic device. The fastener is fastened in the installation cavity, and the fastener is configured to be fastened to the electronic device. The acoustic module is of a structure in which the fastener is wrapped by the speaker mesh. The first end face of the speaker mesh abuts against the electronic device, and the fastener is hidden in the installation cavity of the speaker mesh.

### CROSS-REFERENCE TO RELATED APPLICATIONS

This application is a continuation of International Application No. PCT/CN2023/091354, filed on Apr. 27, 2023, which claims priority to Chinese Patent Application No. 202210483757.5, filed on May 5, 2022. The disclosures of the aforementioned applications are hereby incorporated by reference in their entireties.

### TECHNICAL FIELD

This application relates to the field of electronic device manufacturing, and in particular, to an acoustic module and an electronic device.

### BACKGROUND

An electronic device, for example, a display device, has a function of playing audio. To implement this function, a speaker that converts an electrical signal into a sound signal is disposed in the display device. To ensure that a sound emitted by the speaker has good acoustic characteristics, a speaker mesh needs to be disposed outside the speaker. A wall of the speaker mesh is thin and therefore cannot be directly fastened to a housing of the display device.

FIG. 1 is a diagram of a structure of a display device 200 according to the conventional technology. As shown in FIG. 1, the display device 200 includes a housing 20, a screen assembly 10 disposed in the housing 20, and an acoustic module 30 that is disposed at a lower end of the screen assembly 10 and fastened to the housing 20. The acoustic module 30 includes a decoration part 301 and a speaker mesh 302 disposed at a lower end of the decoration part 301. The decoration part 301 and the speaker mesh 302 are fastened in a manner of adhesion. An upper end of the decoration part 301 is fastened to the housing 20. In this way, in a manner of fastening the decoration part 301 and the housing 20 to the display device 200, the speaker mesh 302 that is fastened to the decoration part 301 is also installed on the display device 200.

However, when the speaker mesh 302 is fastened to the display device 200, there is the decoration part 301 and an adhesive layer (the adhesive layer is formed by fastening the decoration part 301 and the speaker mesh 302 in the manner of adhesion) between the speaker mesh 302 and the screen assembly 10 of the display device 200, and consequently, a structure between the speaker mesh 302 and the screen assembly 10 is not compact.

### SUMMARY

Embodiments of this application provide an acoustic module and an electronic device, to resolve a problem that a structure between the acoustic module and another component of the electronic device is not compact at an installation position of the acoustic module in the electronic device.

To achieve the foregoing objectives, the following technical solutions are used in embodiments of this application.

According to a first aspect, an embodiment of this application provides an acoustic module, where the acoustic module includes a speaker mesh and a fastener, the speaker mesh includes a first end face and a second end face that are opposite to each other, the first end face is provided with an installation cavity that is recessed to the second end face, the second end face is provided with a plurality of sound holes that are connected to the installation cavity, and the first end face is configured to abut against a housing of an electronic device; and the fastener is fastened in the installation cavity, where the fastener is configured to be fastened to the electronic device.

Based on the foregoing description of the acoustic module structure provided in this embodiment of this application, it can be learned that the acoustic module is of a structure in which the fastener is wrapped by the speaker mesh. To be specific, the speaker mesh that is fastened to the fastener is installed on the electronic device in a manner of fastening the fastener to the electronic device. Because the fastener is fastened in the installation cavity of the speaker mesh, when the acoustic module including the speaker mesh and the fastener is fastened to the electronic device, the first end face of the speaker mesh abuts against the electronic device, and the fastener used to fasten the acoustic module to the electronic device is hidden in the installation cavity of the speaker mesh. In this way, viewed from an appearance of the electronic device, the speaker mesh that abuts against the electronic device can be seen, and the fastener, a gap that may exist between the fastener and the speaker mesh, the first adhesive layer that adheres the fastener and the speaker mesh, or the structure that connects the fastener and the electronic device cannot be seen.

Therefore, according to the acoustic module provided in this embodiment of this application, a structure between the acoustic module and the electronic device can be compact, and appearance aesthetics of the electronic device can be improved, thereby improving a visual impact sense for a user.

In a possible implementation of the first aspect, the fastener has a third end face and a fourth end face that are opposite to each other, the third end face is close to the first end face, the fourth end face is close to the second end face, and the fourth end face is provided with an accommodation groove that is recessed to the third end face; and the acoustic module further includes a first adhesive layer, where the first adhesive layer is disposed in the accommodation groove, to fasten the speaker mesh and the fastener. When the first adhesive layer is disposed in the accommodation groove, while a thickness of the first adhesive layer meets an adhesion strength requirement between the speaker mesh and the fastener, a part of the thickness of the first adhesive layer is absorbed by a depth of the accommodation groove. Therefore, although the first adhesive layer is added, because the accommodation groove is disposed on the fourth end surface of the fastener, a total thickness of the acoustic module does not change greatly, which is conducive to a thinning design of the acoustic module.

In a possible implementation of the first aspect, the acoustic module further includes a mesh fabric, where the mesh fabric is located in the installation cavity and is on the plurality of sound holes of the speaker mesh. In this way, when viewed from the outside of the electronic device, the mesh fabric behind the sound holes may be seen from the plurality of sound holes. The mesh fabric is a kind of fabric that is breathable and does not affect an acoustic characteristic. Therefore, disposing the mesh fabric improves appearance aesthetics, and does not affect the acoustic characteristic.

In a possible implementation of the first aspect, an extending part extending towards the interior of the installation cavity is formed on a side wall surface of the installation cavity, so that an insertion groove is formed on the side wall surface of the installation cavity, and an edge of the fastener is disposed in the insertion groove. The extending part is disposed in a part of the installation cavity, so that the fastener is clamped in the installation cavity, thereby enhancing connection reliability between the fastener and the speaker mesh.

In a possible implementation of the first aspect, the fastener is provided with a first clamping groove, and the extending part is disposed in the first clamping groove. By disposing the first clamping groove, a structure thickness of the fastener disposed in the insertion groove is reduced, so that a height of the insertion groove is small. In this way, the thickness of the acoustic module can be reduced to the greatest extent on the premise of ensuring connection reliability between the fastener and the speaker mesh.

In a possible implementation of the first aspect, the acoustic module further includes a clamping structure, where the clamping structure is configured to clamp the edge of the fastener onto the speaker mesh, and the clamping structure and the extending part are disposed on two opposite sides of the fastener. The clamping structure is disposed at a position opposite to the extending part, so that the fastener is clamped in the installation cavity by the clamping structure, thereby enhancing connection reliability between the fastener and the speaker mesh. In addition, the clamping structure and the extending part are disposed opposite to each other, so that a case in which one side of the fastener is tilted can be avoided, and a connection between the fastener and the speaker mesh is more stable.

In a possible implementation of the first aspect, the clamping structure includes an elastic buckle, one end of the elastic buckle is fastened to an outer edge of the speaker mesh, and the other end can be bent and abuts against the fastener. The elastic buckle has a simple structure, has low costs, and is easy to be processed, which facilitates mass production.

In a possible implementation of the first aspect, the fastener is provided with a second clamping groove, and the other end of the elastic buckle is disposed in the second clamping groove. The second clamping groove is disposed to reduce a thickness of the fastener. When the other end of the elastic buckle is disposed in the second clamping groove, a sum of a thickness of the elastic buckle and the thickness of the fastener is reduced accordingly, and the thickness of the acoustic module can be reduced to the greatest extent on the premise that connection reliability between the fastener and the speaker mesh is ensured.

In a possible implementation of the first aspect, the first clamping groove is disposed at an edge of the third end face of the fastener and is recessed to the fourth end face.

In a possible implementation of the first aspect, the first clamping groove is disposed opposite to the extending part.

In a possible implementation of the first aspect, the second clamping groove is disposed at an edge of the third end face of the fastener and is recessed to the fourth end face.

In a possible implementation of the first aspect, the second clamping groove is disposed opposite to the clamping structure.

In a possible implementation of the first aspect, an inner side wall of the speaker mesh is fastened to an outer side wall of the fastener through a second adhesive layer. The outer side wall of the fastener and the inner side wall of the speaker mesh are fastened together in an adhesive manner, so that a structure of a gap formed by the outer side wall of the fastener and the inner side wall of the speaker mesh due to a production process is effectively used. In addition to ensuring connection reliability, a structure of the acoustic module is simple, an appearance is compact, and the acoustic module is suitable for mass production, which helps reduce product costs.

In a possible implementation of the first aspect, a rounded corner is disposed on a prism edge of the second end face of the speaker mesh. When a radius of the rounded corner is less than 0.6 mm, a bluntness sense of the appearance of the speaker mesh can be reduced, which improves appearance aesthetics of the electronic device, and further meets a requirement of the production process.

According to a second aspect, an embodiment of this application provides an electronic device, where the electronic device includes a housing and the foregoing acoustic module, a first end face of a speaker mesh abuts against the housing, and a fastener is fastened to the housing. In this way, in an installation position of the acoustic module in the electronic device, a structure between the acoustic module and a backplane is compact. Viewed from an appearance of the electronic device, the speaker mesh that abuts against the electronic device can be seen, and the fastener, a gap that may exist between the fastener and the speaker mesh, a first adhesive layer that adheres the fastener and the speaker mesh, or the structure that connects the fastener and the electronic device cannot be seen. An appearance of the electronic device according to this embodiment of this application is beautiful.

In a possible implementation of the second aspect, the electronic device is a display device; the display device includes a display, and the display is fastened in the housing; and the acoustic module is disposed at a lower end of the housing.

In a possible implementation of the second aspect, the acoustic module is disposed in a forward direction of the display device. In this way, a user can have a strong feeling of the front speaker, and only the acoustic module and the speaker mesh that abuts against the electronic device can be seen from the outside of the electronic device.

### BRIEF DESCRIPTION OF THE DRAWINGS

FIG. 1 is a diagram of a structure of a display device 200 according to the conventional technology;

FIG. 2 is a diagram of a hardware structure of a display device according to an embodiment of this application;

FIG. 3a is a front view of an electronic device according to an embodiment of this application;

FIG. 3b is a front view of a speaker mesh according to an embodiment of this application;

FIG. 3c is a front view of another speaker mesh according to an embodiment of this application;

FIG. 4a is an exploded diagram of an acoustic module according to an embodiment of this application;

FIG. 4b is a diagram of a structure of a speaker mesh according to an embodiment of this application;

FIG. 5a is an exploded diagram of another acoustic module according to an embodiment of this application;

FIG. 5b is a diagram of a structure of a fastener according to an embodiment of this application;

FIG. 6a is a diagram of a structure of a speaker mesh according to an embodiment of this application;

FIG. 6b is a diagram of a structure in which a clamping structure of the speaker mesh shown in FIG. 6a is in a clamped state;

FIG. 7 is an assembly diagram of an acoustic module according to an embodiment of this application;

FIG. 8 is a cross-sectional view of an acoustic module according to an embodiment of this application;

FIG. 9 is a diagram of a structure of a fastener according to an embodiment of this application;

FIG. 10 is a diagram of a structure obtained after a fastener and a speaker mesh are assembled according to an embodiment of this application;

FIG. 11 is a partial cross-sectional view of an acoustic module according to an embodiment of this application;

FIG. 12 is a diagram of a structure of another speaker mesh according to an embodiment of this application;

FIG. 13a is a partial cross-sectional view of another acoustic module according to an embodiment of this application;

FIG. 13b is a diagram of a structure of the acoustic module shown in FIG. 13a;

FIG. 13c is a partial diagram of a speaker mesh in the acoustic module shown in FIG. 13a;

FIG. 14a is a partial cross-sectional view of still another acoustic module according to an embodiment of this application;

FIG. 14b is a partial cross-sectional view of yet another acoustic module according to an embodiment of this application;

FIG. 14c is a partial cross-sectional view of yet another acoustic module according to an embodiment of this application;

FIG. 15a is an exploded diagram of a structure of an electronic device according to an embodiment of this application; and

FIG. 15b is a rear view of the electronic device shown in FIG. 15a.

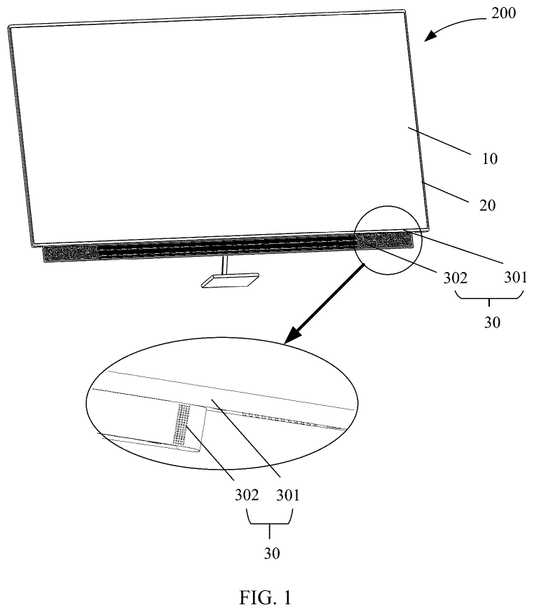

### DETAILED DESCRIPTION OF ILLUSTRATIVE EMBODIMENTS

The following describes the technical solutions in embodiments of this application with reference to the accompanying drawings in embodiments of this application. In the descriptions of this application, “/” represents an “or” relationship between associated objects, unless otherwise specified. For example, a fastener/B may represent the fastener or B. A term “and/or” in this application is merely an association relationship between associated objects, and represents that three relationships may exist. For example, a fastener and/or B may represent the following three cases: Only the fastener exists, both the fastener and B exist, and only B exists, where the fastener and B each may be singular or plural. In addition, in the descriptions of this application, “a plurality of” means two or more than two unless otherwise specified. “At least one of the following items (pieces)” or a similar expression thereof means any combination of these items, including any combination of singular items (pieces) or plural items (pieces). For example, at least one of a fastener, b, or c may represent the fastener, b, c, the fastener and b, the fastener and c, b and c, or the fastener, b, and c, where the fastener, b, and c may be singular or plural. In addition, to clearly describe the technical solutions in embodiments of this application, terms such as first and second are used in embodiments of this application to distinguish between same items or similar items that provide basically same functions or purposes. A person skilled in the art may understand that the terms such as “first” and “second” do not limit a quantity or an execution sequence, and the terms such as “first” and “second” do not indicate a definite difference. In addition, in embodiments of this application, terms such as “example” or “for example” are used to represent giving an example, an illustration, or a description. Any embodiment or design scheme described as an “example” or “for example” in embodiments of this application should not be explained as being more preferred or having more advantages than another embodiment or design scheme. Exactly, use of the terms such as “example” or “for example” is intended to present a related concept in a specific manner for ease of understanding.

Embodiments of this application provide an electronic device. The electronic device may include a display device (for example, a large-screen television), a mobile phone, a tablet computer (pad), an intelligent wearable product (for example, a smartwatch or a smart band), a virtual reality (VR) device, an augmented reality (AR) device, or a device like a home appliance. A specific form of the electronic device is not specially limited in embodiments of this application.

The following uses a television in a display device as an example to describe a structure in this application.

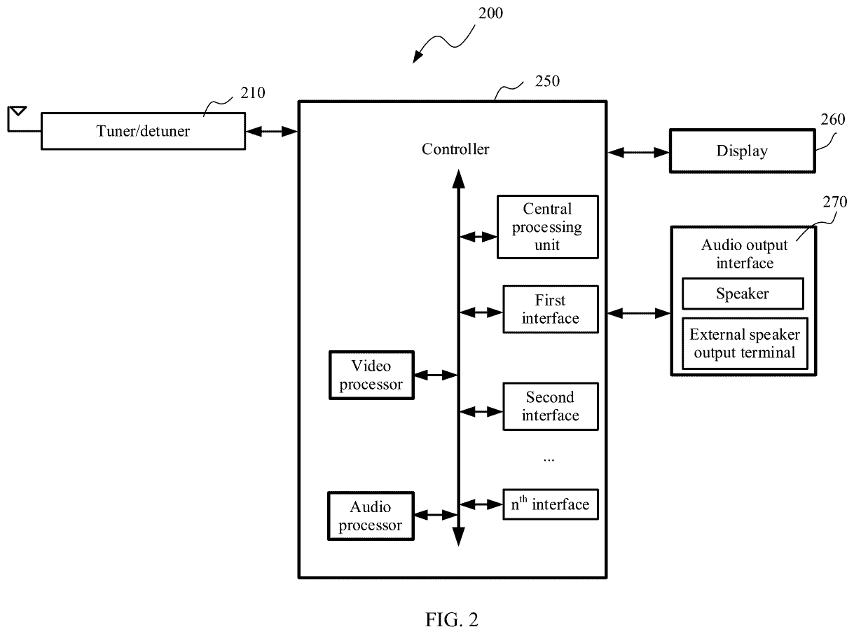

FIG. 2 is a diagram of a structure of a display device according to an embodiment of this application. As shown in FIG. 2, a display device 200 includes a tuner/detuner 210, a controller 250, a display 260, and an audio output interface 270.

In some embodiments, the controller includes a processor, a video processor, an audio processor, and a first interface to an n^{th} interface for input/output.

The display 260 includes a display assembly configured to present an image, and a driver assembly configured to drive image display, and is configured to receive an image signal output by the controller, and display video content, image content, components of a menu manipulation interface, and a user manipulation UI interface.

The display 260 may be a liquid crystal display and a projection display, or may be a projection apparatus and a projection screen.

The tuner/detuner 210 receives a broadcast television signal in a wired or wireless receiving manner, and obtains an audio and video signal through detuning, for example, an EPG data signal, from a plurality of wireless or wired broadcast television signals.

In some embodiments, the controller 250 and the tuner/detuner 210 may be located in different split devices, that is, the tuner/detuner 210 may alternatively be located in an external device of a main device in which the controller 250 is located, for example, an external set-top box.

The controller 250 controls work of the display device and responds to an operation of a user by using various software control programs stored in the memory. The controller 250 controls an overall operation of the display device 200. For example, in response to receiving a user command for selecting a UI object displayed on the display 260, the controller 250 may perform an operation related to the object selected by using the user command.

In some embodiments, the controller includes at least one of a central processing unit (CPU), a video processor, an audio processor, a first interface to an n^{th} interface configured for input/output, a communication bus (Bus), and the like.

The audio output interface 270 includes at least a speaker. The speaker is configured to make a sound.

In some embodiments, a principle of making a sound by the speaker in the display device is as follows: A detector 230 of the display device 200 receives a high-frequency sound signal; the tuner/detuner 210 parses the high-frequency sound signal into an intermediate-frequency sound signal; the controller 250 sends the intermediate-frequency sound signal to a power amplifier circuit, where the power amplifier circuit may be disposed on a mainboard of the display device 200, or may be disposed independently; and the power amplifier circuit amplifies the intermediate-frequency sound signal and couples the amplified sound signal to the speaker. The amplified sound signal is an electrical signal. The speaker converts the electrical signal into audio and plays the audio.

In some embodiments, to reduce sound attenuation as much as possible when the speaker plays a sound, and meet a waterproof and dustproof requirement of the speaker, a speaker mesh is disposed outside the speaker.

In some embodiments, the speaker mesh is thin. To ensure connection reliability between the speaker mesh and a housing of the display device, the speaker mesh cannot be directly fastened to the housing of the display device. Instead, the speaker mesh is first connected to a fastener, and then the fastener is connected to the housing, to implement fastening of the speaker mesh.

In an implementation, the speaker of the display device is disposed at a lower end of the display of the display device. Therefore, the speaker mesh and the fastener are also disposed at the lower end of the display.

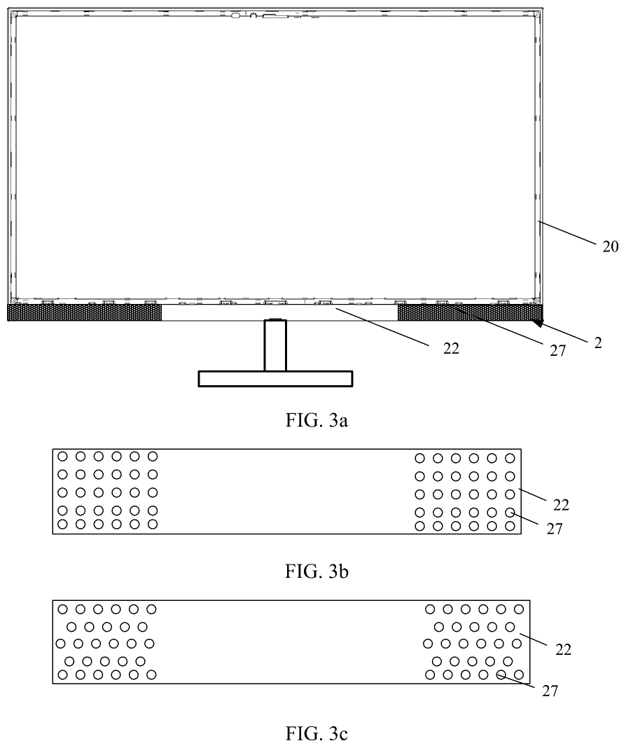

FIG. 3a is a front view of a display device according to an embodiment of this application. As shown in FIG. 3a, the display device includes a housing 20 and a speaker mesh 2, and the speaker mesh 2 is disposed at a lower part of the housing 20 of the display device.

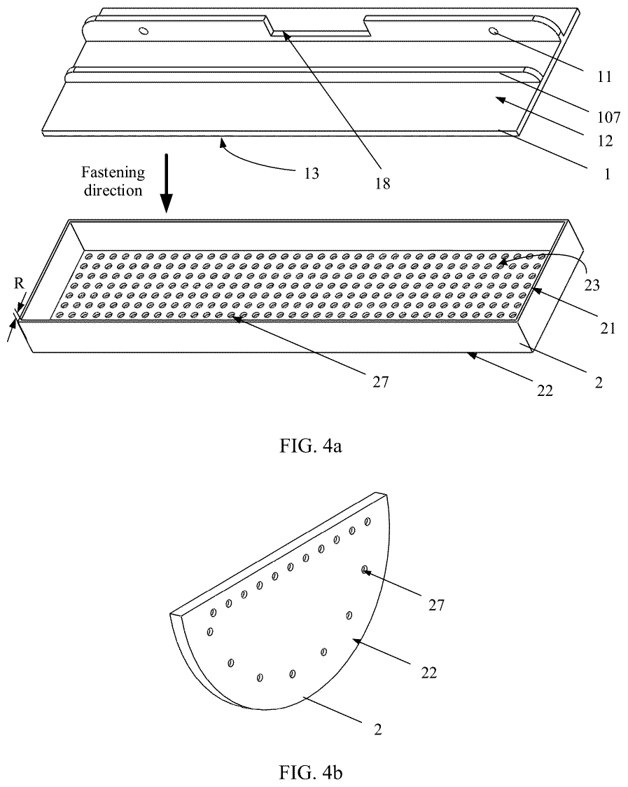

FIG. 4a is an exploded diagram of an acoustic module according to an embodiment of this application. As shown in FIG. 4a, the acoustic module includes a speaker mesh 2 and a fastener 1, and the speaker mesh 2 includes a first end face 21 and a second end face 22 that are opposite to each other.

A part of the first end face 21 is provided with an installation cavity 23 that is recessed to the second end face 22. A cross-sectional area of the installation cavity 23 is less than an area of the first end face 21, so that the installation cavity 23 is a coverless box-shaped structure.

In some embodiments, the installation cavity 23 has four side walls, and there is no gap between connection positions between every two adjacent side walls of the four side walls. From the outside of the speaker mesh 2, the fastener disposed in the installation cavity 23 cannot be seen, which makes an appearance beautiful.

In addition, the second end face 22 is provided with a plurality of sound holes 27 that are connected to the installation cavity 23. The plurality of sound holes 27 may bestrew the second end face 22 shown in FIG. 4a, or may be disposed in a part of the second end face 22 shown in FIG. 3a. A quantity of sound holes is not limited in this application.

In some embodiments, a rounded corner is disposed on a prism edge of the second end face of the speaker mesh, and a radius of the rounded corner is less than 0.6 mm. For example, the radius of the rounded corner may be 0.4 mm.

In an implementation, the plurality of sound holes 27 may be arranged in an array shown in FIG. 3b.

In another implementation, the plurality of sound holes 27 may be arranged in a staggered manner as shown in FIG. 3c.

With reference to FIG. 3a and FIG. 4a, the second end face 22 on which the sound holes 27 are disposed in the speaker mesh 2 is presented on a front surface of the display device, that is, a surface that is directly viewed by a user, and the first end face 21 of the speaker mesh 2 abuts against the housing 20 of the display device.

The sound emitted by the speaker is propagated to the outside of the speaker mesh through the sound hole, so that sound attenuation can be reduced. In addition, a surface in which the sound holes 27 are located faces the user, so that the user can receive sound information from the front side, and the user strongly perceives high-quality sound quality of the front speaker.

The speaker mesh 2 can be implemented by using a plurality of process means. For example, in an implementation, the speaker mesh 2 may be obtained in an impact molding manner.

The speaker mesh 2 has a plurality of shapes. For example, in an implementation, the speaker mesh 2 may be a coverless box-shaped structure shown in FIG. 4a. In another implementation, the speaker mesh 2 may alternatively be a semi-circular box-shaped structure shown in FIG. 4b.

As shown in FIG. 4a, in an implementation, a range of a thickness R of the speaker mesh 2 is from 0.5 mm to 0.6 mm. Certainly, another value range may alternatively be selected. This is not specifically limited in this application.

In the acoustic module provided in this embodiment of this application, as shown in FIG. 4a, the fastener 1 is fastened in the installation cavity 23. The fastener 1 has a third end face 12 and a fourth end face 13 that are opposite to each other, the third end face 12 is close to the first end face 21, and the fourth end face 13 is close to the second end face 22.

In an implementation, a thickness between the third end face 12 and the fourth end face 13 may be 0.5 mm to 0.6 mm. A thin thickness of the fastener 1 helps reduce a height of the installation cavity 23, thereby reducing a thickness of the acoustic module.

In an implementation, the fourth end face 13 of the fastener 1 and a bottom surface of the installation cavity 23 may be fastened through a bi-component adhesive (namely, an AB adhesive) or a double-sided tape. The AB adhesive or the double-sided tape may be disposed at an edge of the bottom surface of the installation cavity 23 and at a position far away from the sound hole 27. When the sound hole 27 is disposed in a part of the second end face 22 as shown in FIG. 3a, the AB adhesive or the double-sided tape may alternatively be disposed at a position that is at a center of the second end face 22 and on which the sound hole 27 is not disposed, to form an acoustic module structure in which the fastener 1 and the speaker mesh 2 are connected.

In the acoustic module provided in this embodiment of this application, the fastener 1 is connected to the housing of the display device, and the first end face 21 of the speaker mesh 2 abuts against the housing of the display device, so that the acoustic module is fastened to the housing of the display device.

There are a plurality of connection structures between the fastener 1 and the housing. The following provides two connection structures that can be implemented.

FIG. 4a shows a connection structure. Specifically, a protruding member 11 extending to the outside of the speaker mesh 2 is disposed on the third end face 12 of the fastener 1, and a through hole adapted to a fastening threaded connector may be disposed on the protruding member 11, so that the threaded connector passes through the through hole and is fastened to the display device. It may be understood that a shape and a size of the protruding member 11 are suitable for a structure of the display device that is assembled with the protruding member 11. The shape and the size of the protruding member 11 of the fastener 1 are not limited in this application.

When the fastener 1 is fastened to the housing of the display device in the manner shown in FIG. 4a, a notch 18 disposed on the protruding member 11 avoids a protruding structure on the housing, so that a weight of the fastener 1 is reduced, and installation of the protruding member 11 and the housing is facilitated.

In an implementation, a reinforcing rib 107 is disposed on the fastener 1. The reinforcing rib 107 is configured to ensure a strength requirement of the fastener 1, and may be used to fasten another part, for example, a rear housing of the display device.

In some other optional connection structures, the connection structure includes a pair of buckling components. One component is connected to the fastener 1, and the other component may be connected to the housing of the display device. The fastener 1 is connected to the housing in a manner of pressing and buckling.

Because the fastener 1 is fastened in the installation cavity 23 of the speaker mesh 2, and the first end face 21 of the speaker mesh 2 abuts against the display device, the speaker mesh 2 that abuts against the display device can be seen from outside the display device. The fastener 1, possible gaps between the fastener 1 and the speaker mesh 2, the adhesive that adheres the fastener 1 and the speaker mesh 2, or the structure that connects the fastener 1 and the display device cannot be seen. Therefore, according to the acoustic module provided in this embodiment of this application, a structure between the acoustic module and the display device can be compact, and appearance aesthetics of the display device can be improved, thereby improving a visual impact sense for a user.

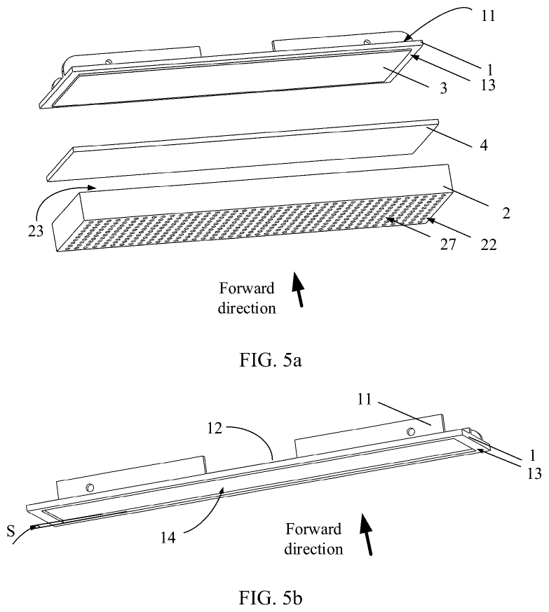

FIG. 5a is an exploded diagram of another acoustic module according to an embodiment of this application. As shown in FIG. 5a, in addition to the speaker mesh 2 and the fastener 1, the acoustic module further includes a first adhesive layer 3 and a mesh fabric 4 disposed in the installation cavity 23. The first adhesive layer 3 is disposed on the fourth end face 13 of the fastener 1, the mesh fabric 4 is disposed between the first adhesive layer 3 and the speaker mesh 2, and the mesh fabric 4 covers the plurality of sound holes 27. In this way, when viewed from a forward direction of the speaker mesh 2, the mesh fabric 4 behind the sound hole 27 is seen, and the first adhesive layer 3 is not seen, thereby improving appearance aesthetics of the display device.

The mesh fabric 4 may be a non-woven fabric, and the non-woven fabric does not affect an acoustic characteristic of the speaker. The mesh fabric may alternatively be another material that does not affect acoustic performance and that is breathable, for example, a needle-punctured non-woven fabric.

FIG. 5b is a diagram of a structure of another fastener according to an embodiment of this application. As shown in FIG. 5b, in some embodiments, a part of the fourth end face 13 of the fastener 1 is provided with an accommodation groove 14 that is recessed to the third end face 12, and the accommodation groove 14 is configured to dispose the first adhesive layer 3. In this way, the accommodation groove 14 may generate a thickness S gain in a forward direction, thereby further reducing the thickness of the acoustic module.

In an implementation, the accommodation groove 14 may be disposed at a central position of the fourth end face 13, and a specific distance is reserved between an edge of the accommodation groove 14 and an edge of the fourth end face 13, so that a distance is ensured between the first adhesive layer 3 and the edge of the fourth end face 13. This helps reduce a thickness of the acoustic component.

Due to a surface of the mesh fabric 4, adhesion reliability between the first adhesive layer 3 and the mesh fabric 4 is not high. Therefore, the speaker mesh 2 and the fastener 1 are fastened only through the first adhesive layer 3, and connection reliability cannot be ensured. To resolve this problem, this embodiment of this application further provides the following several connection structures in which the speaker mesh 2 and the fastener 1 are fastened.

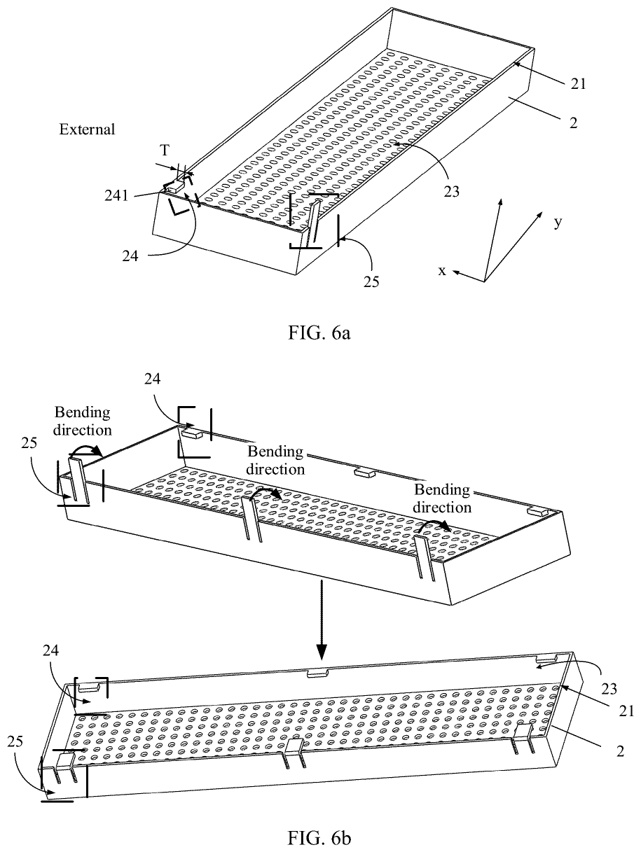

FIG. 6a is a diagram of a structure of a speaker mesh according to an embodiment of this application. As shown in FIG. 6a, an extending part 241 extending towards the interior of the installation cavity 23 is formed on a side wall surface of the installation cavity 23 of the speaker mesh 2. In this way, an insertion groove 24 is formed on the side wall surface of the installation cavity 23, and an edge of the fastener may be disposed in the insertion groove 24. A clamping structure 25 is disposed at a position that is on the side wall surface of the installation cavity 23 and that is opposite to the extending part 241.

In an implementation, the extending part 241 may dig a groove on the side wall surface of the installation cavity 23 in a finishing machining (namely, CNN) manner, to remove an excess material on the side wall surface of the installation cavity 23, so that the extending part 241 is formed on the side wall surface of the installation cavity 23 and forms the insertion groove 24 with the side wall surface of the installation cavity 23.

In another implementation, the extending part 241 may be formed through stamping, on the side wall surface of the installation cavity 23, the extending part 241 extending into the installation cavity 23.

In an implementation, each prism edge of the extending part 241 is designed to have no rounded corner.

In an implementation, a new limiting blunt, file, and extrusion process is used for the extending part 241, to implement a design in which the prism edge of the extending part 241 has no rounded corner.

It may be understood that an upper limit of a width T of the extending part 241 extending towards the interior of the installation cavity 23 is to meet a condition that the fastener 1 can be installed in the installation cavity 23, and a lower limit of the extending width T should be on a basis of meeting fastening reliability of the fastener 1 and the extending part 241.

FIG. 6b is a diagram of a structure in which a clamping structure of the speaker mesh shown in FIG. 6a is in a clamped state. With reference to FIG. 6a and FIG. 6b, in some embodiments, the clamping structure 25 may be a metal sheet connected to the side wall surface of the installation cavity 23, and the metal sheet has a bendable part that can be bent towards the interior of the installation cavity 23. As shown in FIG. 6a, when the clamping structure 25 is in a first state, the metal sheet is in an upright state. As shown in FIG. 6b, when the clamping structure 25 is in a second state, the bendable part of the metal sheet is bent inwards in a direction pointing to the installation cavity 23, so that the fastener is fastened by the metal sheet.

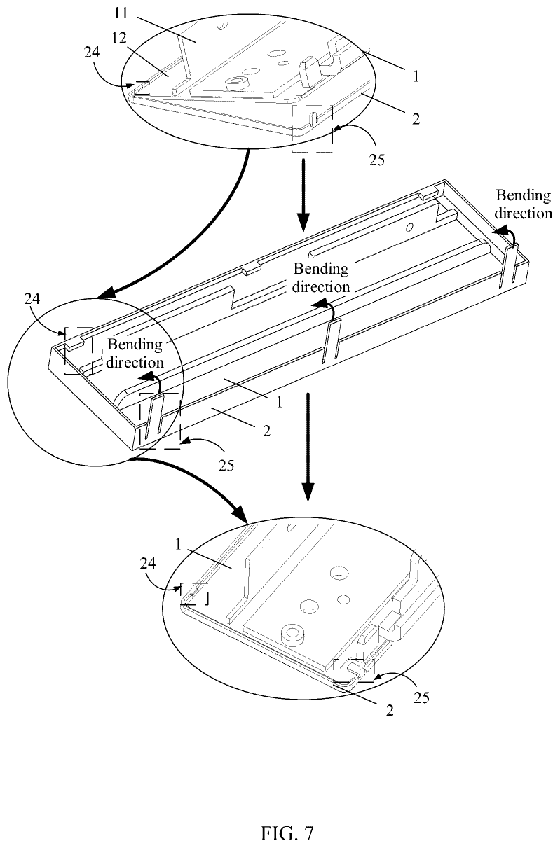

FIG. 7 is an assembly diagram of an acoustic module according to an embodiment of this application. As shown in FIG. 7, a process of installing the fastener to the speaker mesh shown in FIG. 6a and FIG. 6b is as follows.
S100: Keep the speaker mesh 2 in a posture in which the installation cavity 23 faces upward, and make sure that the bendable part of the metal sheet of the clamping structure 25 is in an upright state.
S200: Keep the fastener 1 in a posture in which the protruding member 11 faces upward, and obliquely insert the fastener 1 into the installation cavity 23 of the speaker mesh 2, so that an edge of the third end face 12 of the fastener 1 is located in the insertion groove 24.
S300: Naturally drop the fastener 1, so that the third end face 12 of the fastener 1 completely enters the installation cavity 23.
S400: Bend the bendable part of the metal sheet of the clamping structure 25 in the direction pointing to the installation cavity 23, so that the bendable part of the metal sheet is in contact with the third end face 12 of the fastener 1, so as to clamp the fastener 1 into the installation cavity 23.

By performing steps S100 to S400, the fastener 1 and the speaker mesh 2 are fastened together.

In some embodiments, only one extending part 241 may be disposed as shown in FIG. 6a, or three extending parts 241 may be disposed as shown in FIG. 6b, or a plurality of extending parts 241 may be disposed according to a size of the speaker mesh. A quantity of clamping structures 25 disposed opposite to the extending part 241 may be the same as a quantity of the extending parts 241, or may be less than the quantity of the extending parts 241.

In some embodiments, the extending part 241 and the clamping structure 25 may be disposed in a staggered manner.

According to the acoustic module provided in this embodiment, the extending part 241 and the clamping structure 25 that are opposite to each other are disposed, and the fastener 1 is clamped in the installation cavity 23 of the speaker mesh 2, thereby ensuring connection reliability between the fastener 1 and the speaker mesh 2.

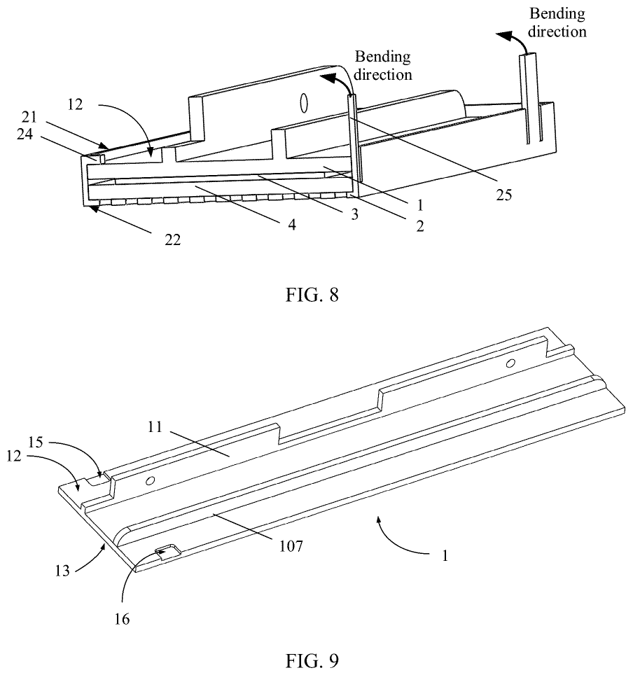

FIG. 8 is a cross-sectional view of an acoustic module according to an embodiment of this application. As shown in FIG. 8, in some embodiments, in addition to the fastener 1 and the speaker mesh 2, the acoustic module further includes a first adhesive layer 3 and a mesh fabric 4. An installation process of the speaker module shown in FIG. 8 is as follows.
S10: Dip the mesh fabric 4 into a water-based adhesive.
S20: Adhere the mesh fabric 4 dipped with the water-based adhesive into the installation cavity 23 of the speaker mesh 2, where the mesh fabric 4 is adhered to the sound holes 27 to form a first assembly.
S30: Adhere the first adhesive layer 3 to the fourth end face 13 of the fastener 1, and ensure that the first adhesive layer 3 is within the fourth end face 13 and does not exceed edges of the fourth end face 13.

In an implementation, a minimum distance needs to be ensured between the first adhesive layer 3 and the edge of the fourth end face 13.

In an implementation, the first adhesive layer 3 may include a plurality of adhesive blocks.

After steps S10 to S30 are performed, steps S100 to S400 are performed, to complete installation of the acoustic module. Because the first adhesive layer 3 and the mesh fabric 4 are disposed between the fastener 1 and the speaker mesh 2, the first adhesive layer 3 and the mesh fabric 4 are also fastened in the installation cavity 23.

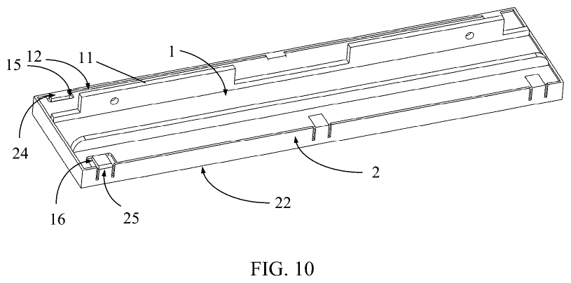

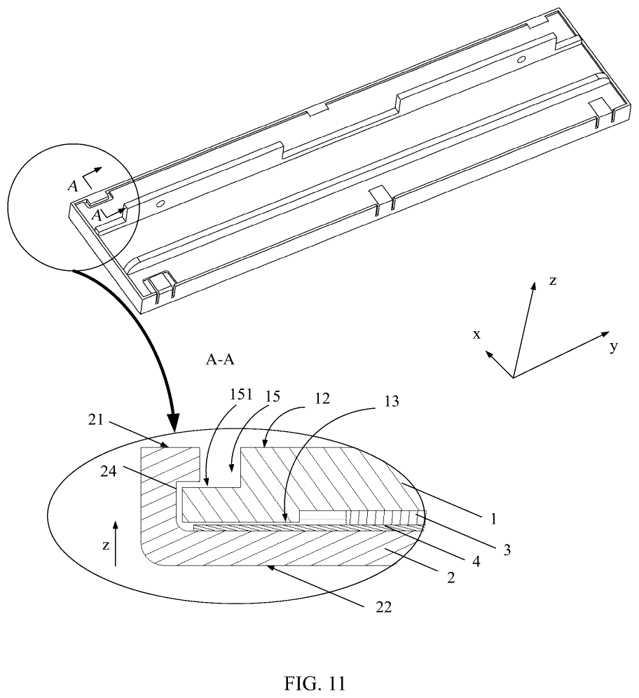

FIG. 9 is a diagram of a structure of another fastener according to an embodiment of this application. FIG. 10 is a diagram of a structure obtained after a fastener and a speaker mesh are assembled according to an embodiment of this application. With reference to FIG. 9 and FIG. 10, in some embodiments, edges of the third end face 12 of the fastener 1 are provided with a first clamping groove 15 and a second clamping groove 16 that are recessed to the fourth end face 13.

After the fastener 1 is installed in the installation cavity 23 of the speaker mesh 2, the first clamping groove 15 is disposed opposite to the extending part 241, and is located on a side that is of the extending part 241 and that is close to the second end face 22. The second clamping groove 16 is disposed opposite to the clamping structure 25, and is located on a side that is of the clamping structure 25 and that is close to the second end face 22.

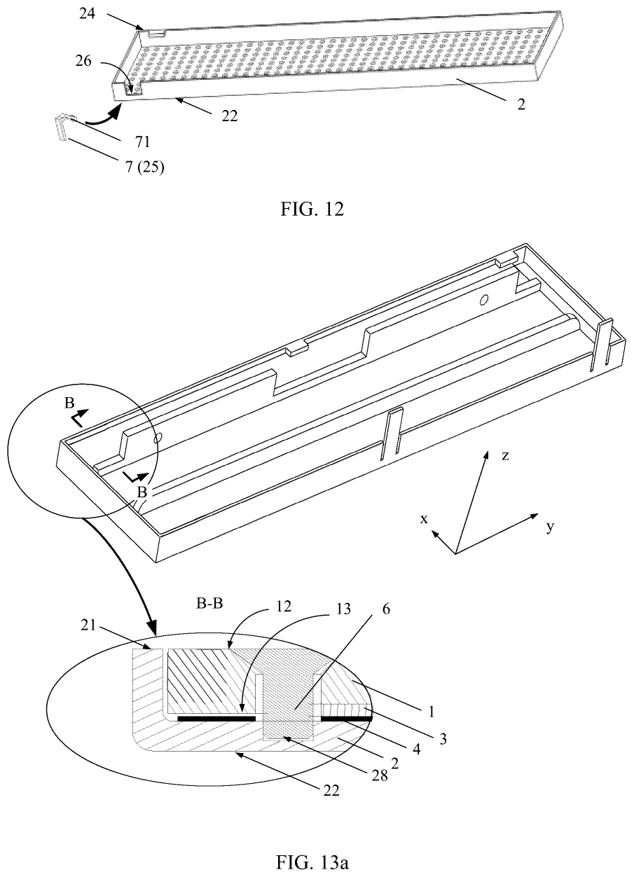

FIG. 11 is a partial cross-sectional view of an acoustic module according to an embodiment of this application. As shown in FIG. 11, in some embodiments, because the first clamping groove 15 and the second clamping groove 16 are disposed on the third end face 12 of the fastener 1, after the fastener 1 and the speaker mesh 2 are assembled, a surface that is of the fastener 1 and that is in contact with the extending part 241 is a first surface 151 of the first clamping groove 15. The first surface 151 is between the third end face 12 and the fourth end face 13.

It can be learned that, compared with that the structure between the third end face 12 and the fourth end face 13 is directly disposed in the extending part 241 shown in FIG. 8, as shown in FIG. 11, when the structure between the first surface 151 and the fourth end face 13 is disposed in the extending part 241, a height of the insertion groove 24 shown in FIG. 11 in a z direction is small. In this way, the thickness of the acoustic module can be reduced to the greatest extent on the premise of ensuring connection reliability between the fastener 1 and the speaker mesh 2.

In an implementation, the third end face 12 of the fastener 1 and the first end face 21 of the speaker mesh 2 are located on a same plane. When the first end face 21 abuts against the housing of the display device, the third end face 12 of the fastener 1 is also located on the same plane. When viewed from outside the electronic device, the speaker mesh that abuts against the electronic device can be seen, and a structure of the fastener cannot be seen, thereby improving appearance aesthetics of the display device.

FIG. 12 is a diagram of a structure of another speaker mesh according to an embodiment of this application. As shown in FIG. 12, the clamping structure 25 may alternatively be an elastic press-type buckle 7. A groove 26 opposite to the extending part 241 is provided on a side wall of the speaker mesh, and the press-type buckle 7 is disposed in the groove 26. After the buckle is pressed into the speaker mesh 2, a first end 71 of the press-type buckle 7 pops up above the fastener, to complete fastening of the speaker mesh and the fastener.

The following describes in detail other fastening manners between the speaker mesh 2 and the fastener 1.

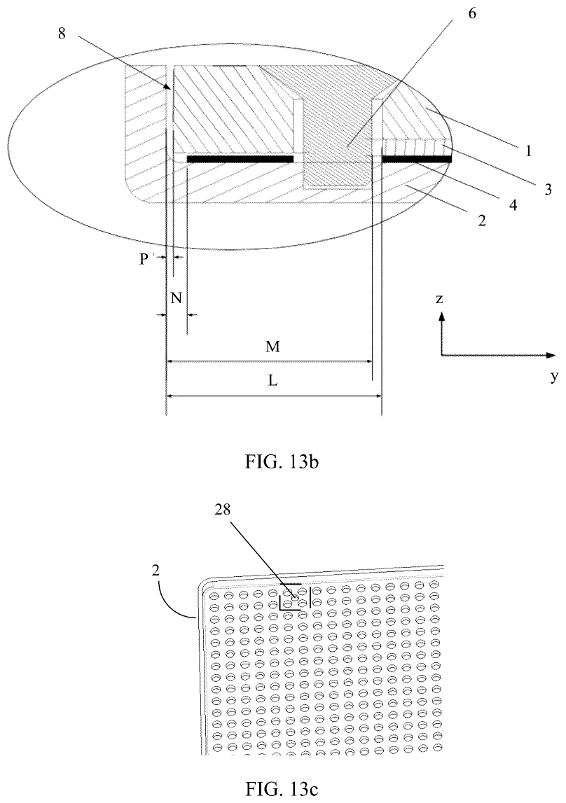

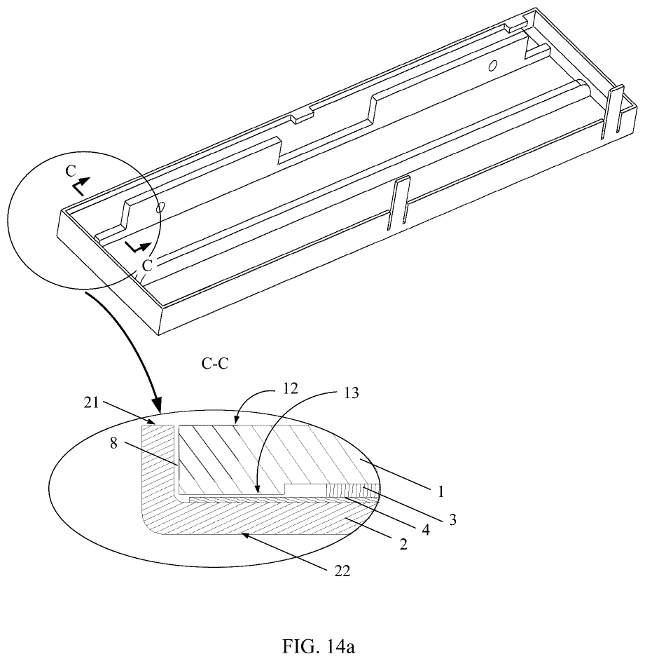

FIG. 13a is a partial cross-sectional view of another acoustic module according to an embodiment of this application. As shown in FIG. 13a, in some embodiments, a thickness of the speaker mesh 2 is large, and a spacing between sound holes on the speaker mesh 2 is large. To ensure connection reliability between the speaker mesh 2 and the fastener 1, the fastener 1 and the speaker mesh 2 are connected together through a threaded connector 6.

As shown in FIG. 13a, in an implementation, the acoustic module includes a fastener 1, a speaker mesh 2, a first adhesive layer 3, and a mesh fabric 4. A threaded connector 6 passes through an installation hole disposed on the fastener 1, then passes through a through hole corresponding to the mesh fabric 4, and is screwed to a threaded hole 28 on the speaker mesh 2.

FIG. 13b is a diagram of a structure of the acoustic module shown in FIG. 13a. As shown in FIG. 13b, in a positive direction of a y direction (the y direction is a long side direction of the acoustic module), a distance between an edge of the first adhesive layer 3 and an inner side wall of the speaker mesh 2 is a first distance L, and a distance between the threaded connector 6 and the inner side wall of the speaker mesh 2 is a second distance M, where L is greater than M. A distance between an edge of the mesh fabric 4 and the inner side wall of the speaker mesh 2 is a third distance N, where M is greater than N. There is a gap 8 between a side wall of the fastener 1 and the inner side wall of the speaker mesh 2, and a width of the gap 8 in the y direction is a fourth distance P, where N is greater than P. In this way, the closer to the inner side wall of the speaker mesh 2, the more the gaps between the components are. This facilitates assembly of the components of the acoustic module, and can further reduce a requirement for processing precision of each component, thereby reducing costs.

FIG. 13c is a partial diagram of a speaker mesh in the acoustic module shown in FIG. 13a. As shown in FIG. 13c, in an implementation, the threaded hole on the speaker mesh 2 is disposed at a central position of an area in which four sound holes arranged in an array are located.

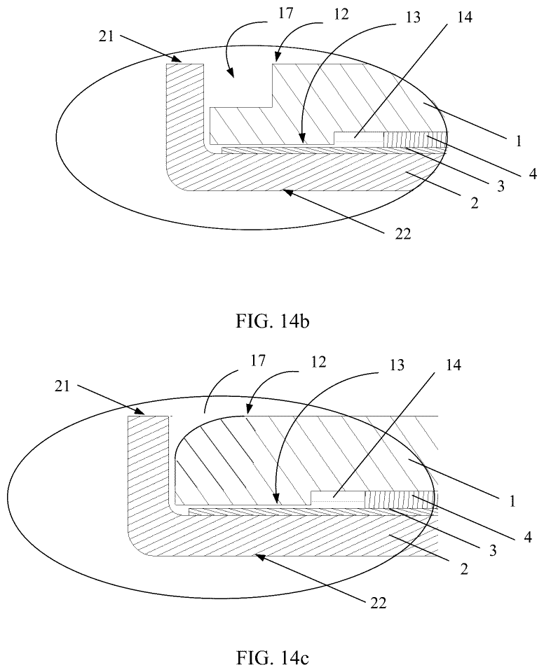

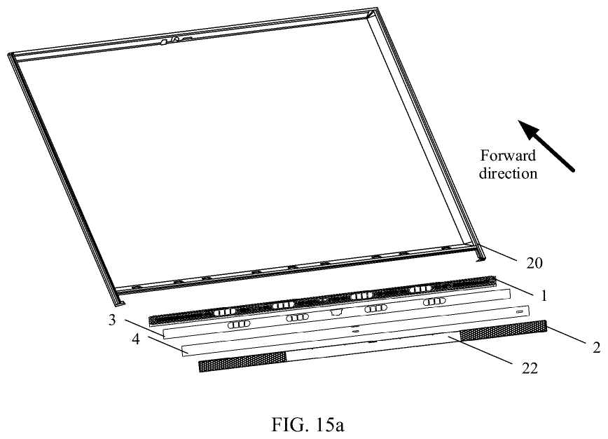

FIG. 14a is a partial cross-sectional view of still another acoustic module according to an embodiment of this application. As shown in FIG. 14a, there is a gap 8 between the side wall of the fastener 1 and the inner side wall of the speaker mesh 2, and an adhesive is dispensed in the gap 8. The adhesive may be an AB adhesive or may be a water-based adhesive.

In another implementation, a second adhesive layer is disposed between the inner side wall of the speaker mesh 2 and an outer side wall of the fastener 1, where the second adhesive layer is of a double-sided adhesive structure, and the second adhesive layer is configured to fasten the speaker mesh 2 and the fastener 1. FIG. 14b is a partial cross-sectional view of yet another acoustic module according to an embodiment of this application. As shown in FIG. 14b, an overflow adhesive groove 17 that is recessed towards the fourth end face 13 is disposed on an edge of the third end face 12 of the fastener 1, and is configured to accommodate an adhesive overflowed in the gap 8. The overflow adhesive groove 17 may be a square step groove shown in FIG. 14b, or may be an arc-shaped groove shown in FIG. 14c.

In the acoustic modules shown in FIG. 14a and FIG. 14b, the side wall of the fastener 1 and the outer side wall of the speaker mesh 2 are fastened together in a manner of adhesive, so that a structure of the gap 8 generated due to a production process is effectively used. In addition to ensuring connection reliability, the acoustic module can further have a simple structure and a compact appearance, which is suitable for mass production and helps reduce product costs.

In addition, dispensing the adhesive on the side wall of the product does not affect working of the sound hole of the speaker mesh, which can meet a requirement for acoustic features.

An embodiment of this application provides a manner of connecting a fastener to a housing of a display device. The following provides a description with reference to the accompanying drawings.

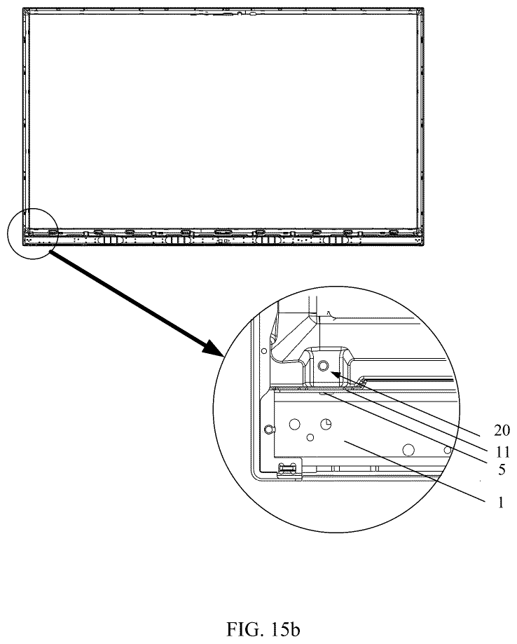

FIG. 15a is an exploded diagram of a structure of an electronic device according to an embodiment of this application. As shown in FIG. 15a, the display device includes a fastener 1 and a speaker mesh 2, and the fastener 1 is configured to be fastened to the speaker mesh 2 and fastened to the display device. In this way, the speaker mesh 2 is fastened to the display device. In a forward direction of the display device, the fastener 1 is disposed behind the speaker mesh 2. In this way, after the fastener 1 is fastened to the display device, a second end face 22 of the speaker mesh 2 can be seen from the forward direction of the display device, and the fastener 1 cannot be seen.

FIG. 15b is a rear view of the display device shown in FIG. 15a. With reference to FIG. 15a and FIG. 15b, the display device further includes a screw 5. The fastener 1 includes a protruding member 11. The protruding member 11 is disposed on a back side of the fastener 1 by using the forward direction of the display device as a reference. A through hole is disposed on the protruding member 11. In this way, the screw 5 passes through the through hole on the protruding member 11 and is fastened to a screw hole on a housing 20.

In addition, as shown in FIG. 15a, in an implementation, in the forward direction of the display device, a first adhesive layer 3 may be disposed between the speaker mesh 2 and the fastener 1, and a mesh fabric 4 may be disposed between the speaker mesh 2 and the first adhesive layer 3.

In an implementation, an edge of a second end face 22 of the speaker mesh 2 is made into a rounded corner with a radius less than 0.4 mm, so that the acoustic module and the display device can be more compact in structure after being installed together.

In the foregoing specific implementations, the objectives, technical solutions, and beneficial effect of this application are further described in detail. It should be understood that the foregoing descriptions are merely the specific implementations of this application, but are not intended to limit the protection scope of this application. Any modification, equivalent replacement, improvement, or the like made based on the technical solutions of this application shall fall within the protection scope of this application.

What is claimed is:

1. An acoustic module, comprising:
a speaker mesh comprising a first end face and a second end face that are opposite to each other, the first end face defining an installation cavity that is recessed to the second end face, the second end face defining a plurality of sound holes that are connected to the installation cavity, and the first end face is configured to abut against a housing of an electronic device; and
a fastener, fastened in the installation cavity, and configured to be fastened to the electronic device.

2. The acoustic module according to claim 1, wherein the fastener has a third end face and a fourth end face that are opposite to each other, the third end face is proximate to the first end face, the fourth end face is proximate to the second end face, and the fourth end face defines an accommodation groove that is recessed to the third end face; and
the acoustic module further comprises:
a first adhesive layer disposed in the accommodation groove.

3. The acoustic module according to claim 1, further comprising:
a mesh fabric, located in the installation cavity and covering the plurality of sound holes.

4. The acoustic module according to claim 1, wherein an extending part extending towards an interior of the installation cavity is on a side wall surface of the installation cavity, so that an insertion groove is defined on the side wall surface of the installation cavity, and an edge of the fastener is disposed in the insertion groove.

5. The acoustic module according to claim 4, wherein the fastener defines a first clamping groove, and the extending part is disposed in the first clamping groove.

6. The acoustic module according to claim 4, further comprising:
a clamping structure configured to clamp the edge of the fastener onto the speaker mesh, and the clamping structure and the extending part are disposed on two opposite sides of the fastener.

7. The acoustic module according to claim 6, wherein the clamping structure comprises an elastic buckle, a first end of the elastic buckle is fastened to an outer edge of the speaker mesh, and a second end of the elastic buckle is configured to be bent and abuts against the fastener.

8. The acoustic module according to claim 7, wherein the fastener defines a second clamping groove, and the second end of the elastic buckle is disposed in the second clamping groove.

9. The acoustic module according to claim 1, wherein an inner side wall of the speaker mesh is fastened to an outer side wall of the fastener through a second adhesive layer.

10. The acoustic module according to claim 1, wherein a rounded corner is disposed on a prism edge of the second end face of the speaker mesh.

11. An electronic device, comprising:
a housing; and
an acoustic module, comprising:
a speaker mesh comprising a first end face and a second end face that are opposite to each other, the first end face defining an installation cavity that is recessed to the second end face, the second end face defining a plurality of sound holes that are connected to the installation cavity, and the first end face is configured to abut against a housing of the electronic device; and
a fastener, fastened in the installation cavity, and configured to be fastened to the electronic device,
wherein a first end face of a speaker mesh abuts against the housing, and a fastener is fastened to the housing.

12. The electronic device according to claim 11, wherein the fastener has a third end face and a fourth end face that are opposite to each other, the third end face is proximate to the first end face, the fourth end face is proximate to the second end face, and the fourth end face defines an accommodation groove that is recessed to the third end face; and
the acoustic module further comprises:
a first adhesive layer disposed in the accommodation groove.

13. The electronic device according to claim 11, wherein the acoustic module further comprises:
a mesh fabric, located in the installation cavity and covering the plurality of sound holes.

14. The electronic device according to claim 11, wherein an extending part extending towards an interior of the installation cavity is formed on a side wall surface of the installation cavity, so that an insertion groove is defined on the side wall surface of the installation cavity, and an edge of the fastener is disposed in the insertion groove.

15. The electronic device according to claim 14, wherein the fastener defines a first clamping groove, and the extending part is disposed in the first clamping groove.

16. The electronic device according to claim 14, wherein the acoustic module further comprises:
a clamping structure configured to clamp the edge of the fastener onto the speaker mesh, and the clamping structure and the extending part are disposed on two opposite sides of the fastener.

17. The electronic device according to claim 16, wherein:
the clamping structure comprises an elastic buckle, a first end of the elastic buckle is fastened to an outer edge of the speaker mesh, and a second end of the elastic buckle is configured to be bent and abuts against the fastener; and
the fastener defines a second clamping groove, and the second end of the elastic buckle is disposed in the second clamping groove.

18. The electronic device according to claim 11, wherein an inner side wall of the speaker mesh is fastened to an outer side wall of the fastener through a second adhesive layer.

19. The electronic device according to claim 11, wherein a rounded corner is disposed on a prism edge of the second end face of the speaker mesh.

20. The electronic device according to claim 11, wherein the electronic device is a display device;
the display device comprises a display, and the display is fastened in the housing; and
the acoustic module is disposed at a lower end of the housing.
